(19) United States
(12) Patent Application Publication
(10) Pub. No.: US 2026/0244417 A1
(43) Pub. Date: Aug. 20, 2026

(54) GENERATION OF PROFILING OBJECTS FOR PROFILING PROCESS

(71) Applicant: International Business Machines Corporation, Armonk, NY (US)

(72) Inventor: JIJIANG (GEORGE) XU, OTTAWA (CA)

(21) Appl. No.: 19/053,441

(22) Filed: Feb. 14, 2025

(51) Int. Cl. G06F 8/41; G06F 11/34

(52) U.S. Cl. CPC G06F 8/41; G06F 11/3466; G06F 2201/865

(57) ABSTRACT

Generation of profiling objects for a profiling process includes executing a first source code associated with an application in a computational environment. At least one target class from a set of classes is identified based on a first set of parameters associated with the profiling process and the execution of the first source code. A second source code associated with the profiling process is inserted within the at least one target class based on the identification of the at least one target class. An occurrence of a set of events associated with the at least one target class is detected based on a second set of parameters and the execution of the second source code. A set of profiling objects associated with the computational environment for a set of time periods is generated based on the detection of the occurrence of the set of events.

### BACKGROUND

The disclosure relates generally to the field of executing source codes in computational environments, more particularly, to identify anomalies in source codes during execution of the source codes.

With the advancement of computing technologies, a scalability and a complexity of computational environments have increased. The increased scalability and the increased complexity may be a result of execution of various applications within the computational environments. Examples of the computational environments include a java runtime environment, a network enabled technologies common language runtime (.NET CLR), a Node.js runtime environment, a Golang (Go) runtime environment, a python interpreter, a cloud-based virtual machine, and the like.

### SUMMARY

In various embodiments of the disclosure, a computer-implemented method for generation of profiling objects for profiling process is provided. The computer-implemented method includes executing, by a computer, a first source code associated with an application in a computational environment. The first source code includes a first set of parameters associated with a profiling process. The computer-implemented method further includes identifying, by the computer, at least one target class from a set of classes associated with the first source code based on the first set of parameters and the execution of the first source code. The computer-implemented method further includes inserting, by the computer, a second source code associated with the profiling process within the at least one target class based on the identification of the at least one target class. The second source code includes a second set of parameters associated with the profiling process. The computer-implemented method further includes executing, by the computer, the second source code including the second set of parameters associated with the profiling process. The computer-implemented method further includes detecting, by the computer, an occurrence of a set of events associated with the at least one target class based on the second set of parameters and the execution of the second source code. The computer-implemented method further includes generating, by the computer, a set of profiling objects associated with the computational environment for a set of time periods based on the detection of the occurrence of the set of events. The computer-implemented further includes outputting, by the computer, the set of profiling objects.

Additional technical features and benefits are realized through the techniques of the disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The following description will provide details of preferred embodiments with reference to the following figures wherein:

FIG. 1 is a diagram that illustrates a computational environment for generation of profiling objects for profiling process, in accordance with an embodiment of the disclosure;

FIG. 2 is a diagram that illustrates a system environment for generation of profiling objects for profiling process, in accordance with an embodiment of the disclosure;

FIG. 3A and FIG. 3B collectively are diagrams that illustrate exemplary operations for generation of profiling objects for profiling process, in accordance with an embodiment of the disclosure;

FIG. 4A is a diagram that illustrates an exemplary first user interface for generation of profiling objects for profiling process, in accordance with an embodiment of the disclosure;

FIG. 4B is a diagram that illustrates an exemplary second user interface for generation of profiling objects for profiling process, in accordance with an embodiment of the disclosure; and

FIG. 5 is a diagram that illustrates a flowchart of a method for generation of profiling objects for profiling process, in accordance with an embodiment of the disclosure.

### DETAILED DESCRIPTION

With the advancement of computing technologies, a scalability and a complexity of computational environments have increased. The increased scalability and the increased complexity may be a result of execution of various applications within the computational environments. An example computational environment includes suitable logic, circuitry, and interfaces that are configured to execute one or more instances of various applications based on a predefined execution flow associated with the example computational environment. In an example, the example computational environment is configured to interact with various components of a computer system to execute various applications. Examples of applications include, but are not limited to, programs, classes, methods, objects, variables, threads, and the like. Examples of the computational environments include a java runtime environment, a network enabled technologies common language runtime (.NET CLR), a Node.js runtime environment, a Golang (Go) runtime environment, a python interpreter, a cloud-based virtual machine, and the like.

In an example, execution of the various applications, in the example computational environment, leads to generation of a large volume of data. Further, parsing through the large volume of data leads to identify or detect anomalies is computationally expensive and time consuming. Therefore, there is a need for a computer-implemented method/process/computer system for detecting and resolving the anomalies in such scenarios.

To this end, a profiling process has been widely employed to detect and resolve the anomalies within the example computational environment. The profiling process typically includes generating snapshots (hereinafter, also referred to as “profiling objects”) of a set of processes (hereinafter interchangeably referred to as a set of threads) associated with various applications. In an example, the snapshots of the set of threads correspond to data dumps or logs associated with the set of threads. In an additional example, the profiling objects may further indicate one or more states of the set of threads such as, but are not limited to, a waiting state, a new state, a running state, and a terminated state. In an example, the new state of a thread is indicative of a newly generated thread. Similarly, a running state of the thread is indicative of execution of the thread at a current time period. A waiting state of the thread indicates that the thread is waiting for a computational resource. The terminated state of the thread is indicative of the thread that has either completed execution or has been terminated by the computer system.

In an example, the profiling objects correspond to javacores that are indicative of at least the state of a set of processes executing within the Java environment. Additionally, the javacores are indicative of a state of at least one portion of the Java environment such as (a Java virtual machine (JVM), a class loader, a set of Java class libraries, and the like). In an example, the javacores include JVM diagnostic data indicative of a state of the JVM at a time period. The JVM diagnostic data includes version data associated with a version of the JVM, thread data associated with execution of a set of threads within the JVM, and heap memory data associated with an amount of heap memory utilized by the set of threads. In an additional example, the profiling objects further include system dumps of a user device executing the various applications. The system dumps include system diagnostic data indicative of a state of the user device. In an example, the system diagnostic data include, but is not limited to, memory data associated with a memory of the computer system or operating system data associated with an operating system of the computer system.

However, there are challenges associated with the utilization of the profiling process for detecting and resolving the anomalies within a computational environment. In an example, processing of the large volume of data within the computational environment leads to challenges such as identification of a target thread associated with the anomalies. For example, the computer system may generate a set of threads for executing the various applications within the computational environment. To that end, identifying the target thread causing the anomalies from the set of threads is time consuming. Additionally, the computer system may generate redundant profiling objects (that may not be used for identifying anomalies) for each thread in the set of threads, thereby leading to a wastage of computational resources (such as an amount of memory, an amount of processing power, and the like). Further, the computer system may generate the profiling objects continuously, which leads to large memory and storage usage. Further, parsing through such profiling objects to identify an anomaly, which may have occurred for a time duration of less than 1 second, is time consuming and computationally expensive.

In various embodiments of the disclosure, the computer system may execute a first source code associated with an application in the computational environment. Further, the computer system may identify at least one target class from a set of classes associated with the first source code based on a first set of parameters during execution of the first source code. In an example, the first set of parameters associated with the profiling process includes at least a target class identifier. In an example, the computer system is configured to identify the at least one target class of the set of classes based on the target class identifier. Examples of the class identifier include, but are not limited to, a name of the at least one target class, a unique identifier (ID) associated with the at least one target class, and the like. In an example, the computer system may receive an input from a user device or through a user interface configured to define the first set of parameters associated with the profiling process. In an additional example, the computer system may define the first set of parameters based on historical anomaly data associated with the execution of the first source code. In an example, the computer system may analyze the profiling objects (generated during previous execution of the first source code) to identify the at least one target class that has caused anomalies. Based on the analysis of the profiling objects (generated previously), the computer system may define the first set of parameters. In an example, the computer system may define class names and/or unique IDs associated with the at least one target class as the first set of parameters. The utilization of the first set of parameters mitigates the challenges associated with the identification of the target class from the set of classes. Specifically, the utilization of the target class identifier allows the computer system to generate the set of profiling objects for the target class excluding classes of the set of classes that are different from the target class. Additionally, the utilization of the target class identifier allows the computer system to identify the set of anomalies within the target class, leading to a minimization of the wastage of the computational resources for generating the set of profiling objects for each class of the set of classes.

In various embodiments of the disclosure, the computer system may insert a second source code associated with the profiling process in the at least one target class based on the identification of the at least one target class during the execution of the first source code. Specifically, the computer system is configured to update an intermediate form of the at least one target class to insert the second source code. Those having ordinary skills in the art would appreciate that typically a compiler converts a high level language (such as Java) into an intermediate code that is further converted to a machine language often referred to as low level language. To this end, the computer system is configured to insert the second source code into the intermediate form of the at least one target class. To insert the second source code in the at least one target class, the computer system is configured to generate an intermediate form of the second source code. Further, the computer system is configured to update the intermediate form of the at least one target class to include the intermediate form of the second source code. In various embodiments of the disclosure, the computer system is configured to merge the intermediate form of the at least one target class and the intermediate form of the second source code.

In an example, the second source code includes a second set of parameters associated with the profiling process. In an example, the second set of parameters includes a sequence parameter, a count parameter, a type parameter, and a time period parameter. The utilization of the second set of parameters allows the computer system to detect potential anomalies and actual anomalies within the target class. Specifically, the utilization of the sequence parameter of the second set of parameters allows the computer system to detect the set of anomalies within the target class based on the detection of the occurrence of the set of events associated with the target class. In various embodiments of the disclosure, the sequence parameter corresponds to a set of events associated with the execution of the at least one target class. In an example, the set of events may include, but are not limited to, a decrease in a processing speed of the computational environment, and identification of an exception during the execution of the at least one target class. In various embodiments of the disclosure, the type parameter is indicative of a type associated with the set of profiling objects to be generated. Further, the utilization of the type parameter allows for the generation of a type of the set of profiling objects. In various embodiments of the disclosure, the time period parameter associated with the second source code defines a set of time periods for which the profiling objects are generated. In an example, if the time period parameter is defined as 10 seconds, the computer system is configured to generate the profiling object that includes data dump of the set of processes (executed by the computer system during the execution of the first source code) for 10 seconds after the occurrence of an event of the set of events. A person having ordinary skill in the art would appreciate that the scope of the disclosure is not limited to capturing the data dump after the occurrence of the event. In an additional example, the computer system may be configured to generate the profiling object that includes data dump of the set of processes 5 seconds prior to the event and 5 seconds after the event has occurred. Additionally, the person having ordinary skills in the art would appreciate that 5 seconds prior to the event and 5 seconds after the event have been illustrated as an example and the person having ordinary skills in the art may envision every segmentation of the time period, without departing from the scope of the disclosure. In an example, the count parameter is indicative of a count of profiling objects to be generated. The utilization of the count parameter allows for the generation of a number (such as 2, 3, 4, or 10) of profiling objects, thereby minimizing the wastage of the computational resources for generating the profiling objects for each thread associated with the at least one target class. The utilization of the time period parameter and the count parameter allows for controlling a frequency associated with the generation of the set of profiling objects, thereby minimizing the wastage of the computational resources for generating the set of profiling objects for a total time period associated with the execution of the application.

In various embodiments of the disclosure, the computer system is configured to determine whether the set of events is detected during the execution of the at least one target class. In an example in which the computer system identifies the occurrence of at least one sequence parameter during the execution of the at least one target class, the computer system is configured to execute the second source code (inserted in the at least one target class). Based on the execution of the second source code, the computer system is configured to generate the profiling objects based on the second set of parameters associated with the second source code. In an example, the computer system is configured to generate the profiling objects having data dump for a time period defined in the time period parameter (for example, the second set of parameters). Similarly, the computer system is configured to generate a predefined count of the profiling objects based on the count parameter defined in the second set of parameters.

In various embodiments of the disclosure, a computer-implemented method for generation of profiling objects for profiling process is provided. The computer-implemented method includes executing, by a computer, a first source code associated with an application in a computational environment. The first source code includes a first set of parameters associated with a profiling process. The computer-implemented method further includes identifying, by the computer, at least one target class from a set of classes associated with the first source code based on the first set of parameters and the execution of the first source code. The computer-implemented method further includes inserting, by the computer, a second source code associated with the profiling process within the at least one target class based on the identification of the at least one target class. The second source code includes a second set of parameters associated with the profiling process. The computer-implemented method further includes executing, by the computer, the second source code including the second set of parameters associated with the profiling process. The computer-implemented method further includes detecting, by the computer, an occurrence of a set of events associated with the at least one target class based on the second set of parameters and the execution of the second source code. The computer-implemented method further includes generating, by the computer, a set of profiling objects associated with the computational environment for a set of time periods based on the detection of the occurrence of the set of events. The computer-implemented further includes outputting, by the computer, the set of profiling objects.

In various embodiments of the disclosure, the computer-implemented method further includes determining, by the computer, an occurrence of a set of anomalies within the computational environment. The occurrence of the set of anomalies is determined based on the generated set of profiling objects. The computer-implemented method further includes generating, by the computer, a set of resolutions based on the generated set of profiling objects and the determination of the occurrence of the set of anomalies. The set of resolutions is generated to resolve the set of anomalies. The computer-implemented method further includes outputting, by the computer, the set of resolutions.

In various embodiments of the disclosure, the computer-implemented method further includes obtaining, by the computer, historical anomaly data indicative of a historical occurrence of the set of anomalies within the computational environment. The computer-implemented method further includes determining, by the computer, a set of parameter values for each parameter of the first set of parameters based on the historical anomaly data. The computer-implemented method further includes executing, by the computer, the first source code based on the set of parameter values.

In various embodiments of the disclosure, the computer-implemented method further includes obtaining, by the computer, historical anomaly data indicative of a historical occurrence of the set of anomalies within the computational environment. The computer-implemented method further includes determining, by the computer, a set of parameter values for each parameter of the second set of parameters based on the historical anomaly data and the first set of parameters. The computer-implemented method further includes executing, by the computer, the second source code based on the set of parameter values.

In various embodiments of the disclosure, the historical anomaly data includes an identifier associated with each anomaly of the set of anomalies, a duration associated with the historical occurrence of each anomaly of the set of anomalies, one or more reasons associated with the historical occurrence of each anomaly of the set of anomalies, or any combination thereof.

In various embodiments of the disclosure, the computer-implemented method further includes identifying, by the computer, the at least one target class from the set of classes based on an occurrence of each class of the set of classes in a call stack associated with the computational environment. The call stack comprises at least memory addresses of the set of classes associated with the first source code.

In various embodiments of the disclosure, the computer-implemented method further includes executing, by the computer, the first source code based on the first set of parameters. The first set of parameters includes a target class identifier associated with the at least one target class. The computer-implemented method further includes comparing, by the computer, the target class identifier with each identifier of a set of candidate identifiers based on the execution of the first source code. The set of candidate identifiers is associated with the occurrence of each class of the set of classes in the call stack associated with the computational environment. The computer-implemented method further includes determining, by the computer, that a candidate identifier of the set of candidate identifiers corresponds to the target class identifier based on the comparison of the target class identifier with each identifier of the set of candidate identifiers. The candidate identifier is associated with the occurrence of a candidate class of the set of classes. The computer-implemented method further includes identifying, by the computer, the at least one target class from the set of classes based on the determination that the candidate identifier corresponds to the target class identifier.

In various embodiments of the disclosure, the computer-implemented method further includes executing, by the computer, the second source code based on a sequence parameter of the second set of parameters. The sequence parameter is indicative of a set of event identifiers associated with the set of events associated with the at least one target class within the call stack. The computer-implemented method further includes determining, by the computer, a set of candidate event identifiers associated with an occurrence of a candidate set of events associated with the at least one target class within the call stack. The set of candidate event identifiers is determined based on the sequence parameter and the execution of the second source code. The computer-implemented method further includes comparing, by the computer, a sequence of the set of event identifiers with a sequence of the set of candidate event identifiers. The computer-implemented method further includes determining, by the computer, that the sequence of the set of event identifiers corresponds to the sequence of the set of candidate event identifiers, based on the comparison of the sequence of the set of event identifiers with the sequence of the set of candidate event identifiers. The computer-implemented method further includes detecting, by the computer, the occurrence of the set of events associated with the at least one target class within the call stack based on the determination that the sequence of the set of event identifiers corresponds to the sequence of the set of candidate event identifiers.

In various embodiments of the disclosure, the computer-implemented method further includes generating, by the computer, a profiling thread based on the detection of the occurrence of the set of events associated with the at least one target class within the call stack and the second set of parameters. The second set of parameters includes a type parameter indicative of a type associated with the set of profiling objects, a count parameter indicative of a count associated with the generation of the set of profiling objects, a time period parameter indicative of the set of time periods associated with the generation of the set of profiling objects, or any combination thereof.

In various embodiments of the disclosure, the computer-implemented method further includes executing, by the computer, the profiling thread based on the type parameter, the count parameter, the time period parameter, or any combination thereof. The computer-implemented method further includes generating, by the computer, the set of profiling objects associated with the computational environment for the set of time periods based on the execution of the profiling thread.

In various embodiments of the disclosure, the computer-implemented method further includes determining, by the computer, a completion of the generation of each profiling object of the set of profiling objects based on the execution of the profiling thread. The computer-implemented method further includes executing, by the computer, a thread termination operation for the profiling thread based on the determination of the completion of the generation of each profiling object of the set of profiling objects.

In various embodiments of the disclosure, the computer-implemented method further includes executing, by the computer, the profiling thread based on the count parameter, the time period parameter, and the type parameter being indicative of at least a first type associated with the set of profiling objects. The computer-implemented method further includes generating, by the computer, the set of profiling objects including a first set of profiling objects associated with the computational environment based on the first type associated with the set of profiling objects and the execution of the profiling thread. Each profiling object of the first set of profiling objects is indicative of at least first state data associated with a state of the computational environment for the set of time periods. The first set of profiling objects is generated for the set of time periods.

In various embodiments of the disclosure, the computer-implemented method further includes executing, by the computer, the profiling thread based on the count parameter, the time period parameter, and the type parameter further indicative of a second type associated with the set of profiling objects. The computer-implemented method further includes generating, by the computer, the set of profiling objects including a second set of profiling objects associated with a user device based on the second type associated with the set of profiling threads and the execution of the profiling thread. Each profiling object of the second set of profiling objects is indicative of at least second state data associated with a state of the user device for the set of time periods. The second set of profiling objects is generated for the set of time periods.

In various embodiments of the disclosure, the computer-implemented method further includes obtaining, by the computer, a first input indicative of a set of parameter values for each parameter of the first set of parameters from a user associated with the profiling process. The computer-implemented method further includes executing, by the computer, the first source code based on the set of parameter values.

In various embodiments of the disclosure, the computer-implemented method further includes obtaining, by the computer, a second input indicative of a set of parameter values for each parameter of the second set of parameters from a user associated with the profiling process. The computer-implemented method further includes executing, by the computer, the second source code based on the set of parameter values.

In various embodiments of the disclosure, a computer system for generation of profiling objects for profiling process is provided. The computer system includes a processor set, one or more computer-readable storage media, and program instructions stored on the one or more computer-readable storage media. The program instructions are executable by the processor set to cause the processor set to execute a first source code associated with an application in a computational environment. The first source code includes a first set of parameters associated with a profiling process. The program instructions further cause the processor set to identify at least one target class from a set of classes associated with the first source code based on the first set of parameters and the execution of the first source code. The program instructions further cause the processor set to insert a second source code associated with the profiling process within the at least one target class based on the identification of the at least one target class. The second source code includes a second set of parameters associated with the profiling process. The program instructions further cause the processor set to execute the second source code and the second set of parameters associated with the profiling process. The program instructions further cause the processor set to detect an occurrence of a set of events associated with the at least one target class based on the second set of parameters and the execution of the second source code. The program instructions further cause the processor set to generate a set of profiling objects associated with the computational environment for a set of time periods based on the detection of the occurrence of the set of events. The program instructions further cause the processor set to output the set of profiling objects.

In various embodiments of the disclosure, the program instructions further cause the processor to determine an occurrence of a set of anomalies within the computational environment. The occurrence of the set of anomalies is determined based on the generated set of profiling objects. The programs instructions further cause the processor set to generate a set of resolutions based on the generated set of profiling objects and the determination of the occurrence of the set of anomalies. The set of resolutions is generated to resolve the set of anomalies. The program instructions further cause the processor set to output the set of resolutions.

In various embodiments of the disclosure, the program instructions further cause the processor set to obtain historical anomaly data indicative of a historical occurrence of the set of anomalies within the computational environment. The program instructions further cause the processor set to determine a set of parameter values for each parameter of the first set of parameters based on the historical anomaly data. The program instructions further cause the processor set to execute the first source code based on the set of parameter values.

In various embodiments of the disclosure, the program instructions further cause the processor set to obtain historical anomaly data indicative of a historical occurrence of the set of anomalies within the computational environment. The program instructions further cause the processor set to determine a set of parameter values for each parameter of the set of parameters based on the historical anomaly data and the first set of parameters. The program instructions further cause the processor set to execute the second source code based on the set of parameter values.

In various embodiments of the disclosure, a computer program product for generation of profiling objects for profiling process is provided. The computer program product includes one or more computer-readable storage media. The program instructions are stored on the one or more computer-readable storage media to perform operations. The operations include executing a first source code associated with an application in a computational environment. The first source code includes a first set of parameters associated with a profiling process. The operations include identifying, by the computer, at least one target class from a set of classes associated with the first source code based on the first set of parameters and the execution of the first source code. The operations include inserting, by the computer, a second source code associated with the profiling process within the at least one target class based on the identification of the at least one target class. The second source code includes a second set of parameters associated with the profiling process. The operations include executing the second source code including the second set of parameters associated with the profiling process. The operations include detecting an occurrence of a set of events associated with the at least one target class based on the second set of parameters and the execution of the second source code. The operations include generating a set of profiling objects associated with the computational environment for a set of time periods based on the detection of the occurrence of the set of events. The operations include outputting the set of profiling objects.

Various aspects of the disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or freely propagating electromagnetic waves, electromagnetic waves propagating through a waveguide, light pulses passing through a fiber optic cable, electrical signals communicated through a wire, and/or transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

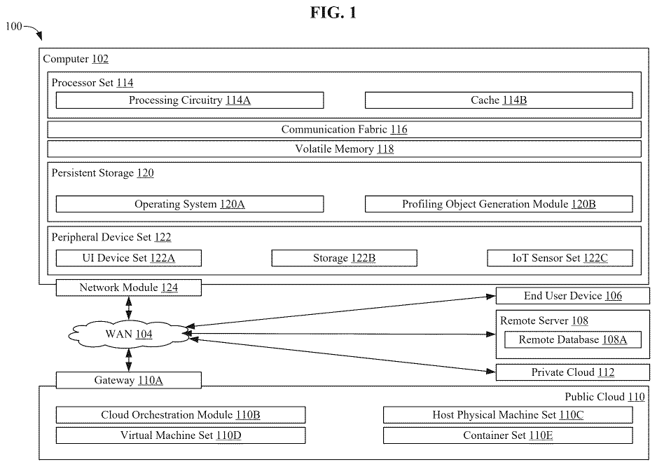

FIG. 1 is a diagram that illustrates a computing environment for generation of profiling objects for profiling process, in accordance with an embodiment of the disclosure. With reference to FIG. 1, there is shown a computing environment 100 that contains an example of an environment for execution of at least some of the computer code/module involved in performing the methods, such as a profiling object generation module 120B. In addition to the profiling object generation module 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the profiling object generation module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or wearable computer, a mainframe computer, a quantum computer, or any form of a computer or a mobile device now known or to be developed in the future that is capable of running a program, accessing a network or querying a database, such as a remote database 108A. As is well understood in the art of computer technology, and depending upon the technology, the performance of a computer-implemented method may be distributed among multiple computers and/or between multiple locations. Alternatively, in this presentation of the computing environment 100, detailed discussion is focused on a single computer, specifically the computer 102, to keep the presentation as simple as possible. The computer 102 may be located in a cloud, even though it is not shown in a cloud in FIG. 1. Alternatively, computer 102 is not needed to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the methods”). These computer-readable program instructions are stored in various types of computer-readable storage media, such as the cache 114B and various storage media discussed below. The program instructions, and associated data, are accessed by the processor set 114 to control and direct the performance of the methods. In computing environment 100, at least some of the instructions for performing the methods may be stored in the dynamic modification of the profiling object generation module 120B in persistent storage 120.

The communication fabric 116 is the signal conduction path that allows the various components of computer 102 to communicate among themselves. Typically, this fabric is made of switches and electrically conductive paths, such as the switches and electrically conductive paths that make up buses, bridges, physical input/output ports, and the like. Various types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not needed unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the profiling object generation module 120B typically includes at least some of the computer code involved in performing the disclosed methods.

The peripheral device set 122 includes the set of peripheral devices of computer 102. Data communication connections between the peripheral devices and the various components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 is needed to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, one sensor may be a thermometer, and various sensor may be a motion detector.

The network module 124 is the collection of computer software, hardware, and firmware that allows computer 102 to communicate with various computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In an embodiment of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by various computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or various computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

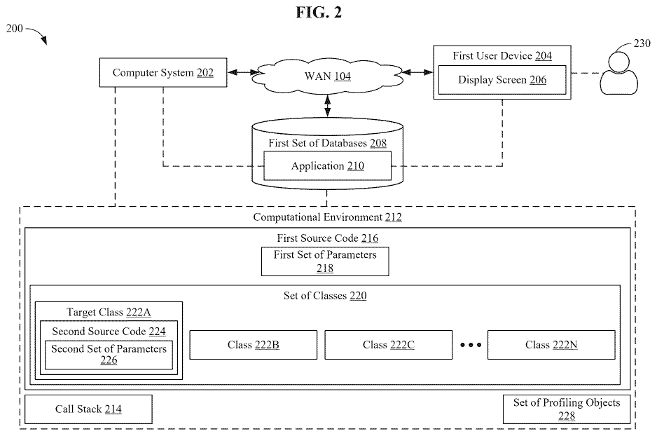

FIG. 2 is a diagram that illustrates a system environment 200 for generation of profiling objects for profiling process, in accordance with an embodiment of the disclosure. FIG. 2 is explained in conjunction with elements from FIG. 1. The system environment 200 includes a computer system 202 and a first user device 204 that includes a display screen 206. The system environment 200 further includes a first set of databases 208 configured to store an application 210. In an example, the computer system 202, the first user device 204, and the set of databases 208 are communicatively coupled with through the WAN 104 of FIG. 1. The computer system 202 further includes the computational environment 212. Further, a call stack 214 is associated with the computational environment 212. The computational environment 212 is configured to deploy a first source code 216 associated with the application 210. The first source code includes a first set of parameters 218 associated with the profiling process. The first source code 216 further includes a set of classes 220. In an example, the set of classes 220 includes at least one target class 222A (hereinafter may be referred to as “target class 222A), a class 222B, a class 222C, up to a class 222N. The computational environment 212 further includes a second source code 224 associated with the profiling process. The second source code further includes a second set of parameters 226 associated with the profiling process. In an embodiment of the disclosure, the computer system 202 is configured to generate a set of profiling objects 228 associated with the profiling process. Further, a user 230 is associated with the first user device 204. In an embodiment of the disclosure, the computer system 202 is an exemplary embodiment of the computer 102 in FIG. 1. Similarly, in an embodiment of the disclosure, the first user device 204 is an example embodiment of the EUD 106 of FIG. 1.

The computer system 202 is configured to execute the first source code 216 associated with the application 210 in the computational environment 212. The first source code 216 includes a first set of parameters 218 associated with the profiling process. The computer system 202 is further configured to identify the target class 222A from the set of classes 220 associated with the first source code 216 based on the first set of parameters 218 and the execution of the first source code 216. The computer system 202 is further configured to insert the second source code 224 associated with the profiling process within the target class 222A based on the identification of the target class 222A. The second source code 224 includes the second set of parameters 226 associated with the profiling process. The computer system 202 is further configured to execute the second source code 224 associated with the profiling process. The computer system 202 is further configured to detect an occurrence of a set of events associated with the target class 222A based on the second set of parameters 226 and the execution of the second source code 224. The computer system 202 is further configured to generate the set of profiling objects 228 associated with the computational environment 212 for a set of time periods based on the detection of the occurrence of the set of events. The computer system 202 is further configured to output the set of profiling objects 228.

Examples of the computer system 202 include but are not limited to, a server, a computing device, a virtual computing device, a mainframe machine, a computer workstation, a smartphone, a cellular phone, a mobile phone, a gaming device, or a consumer electronic (CE) device. In an example embodiment of the disclosure, the computer system 202 may be embodied as a cloud-based service, a cloud-based application, a cloud-based platform, a remote server-based service, a remote server-based application, a remote server-based platform, or a virtual computing system.

The first user device 204 may include suitable logic, circuitry, interfaces, and/or code that are configured to transmit the first set of parameters 218, the second set of parameters 226, or a combination thereof to the computer system 202. In an embodiment of the disclosure, the first user device 204 is configured to transmit the first set of parameters 218, the second set of parameters 226, or a combination thereof to the computational environment 212 in the computer system 202. In an embodiment, the first user device 204 may include the display screen 206. In an embodiment of the disclosure, the first user device 204 is further configured to display the first set of parameters 218, the second set of parameters 226, or a combination thereof on the display screen 206 associated with the first user device 204. The first user device 204 may be associated with the user 230. In an embodiment of the disclosure, the user 230 may correspond to a stand-alone user (such as a developer of the application 210, a tester of the application 210, an end user of the application 210, and the like). Examples of the first user device 204 may include, but are not limited to, a computing device, a mainframe machine, a server, a computer work-station, a smartphone, a cellular phone, a mobile phone, a gaming device, a consumer electronic (CE) device, a head-mounted device, a Virtual Reality (VR) Headset, an Augmented Reality (AR) Device, a Mixed Reality (MR) Device, a Projection-based System, and/or any device with computer vision display capabilities.

The display screen 206 may include suitable logic, circuitry, and interfaces that are configured to render the generated set of profiling objects. In some embodiments of the disclosure, the display screen 206 may be an external display device associated with the first user device 204. The display screen 206 may be a touch screen which may enable the user 230 to provide the first set of parameters 218, the second set of parameters 226, or a combination thereof. The touch screen may be at least one of a resistive touch screen, a capacitive touch screen, or a thermal touch screen. In accordance with an embodiment of the disclosure, the display screen 206 may refer to a display screen of a head-mounted device (HMD), a smart-glass device, a see-through display, a projection-based display, an electro-chromic display, or a transparent display. In some embodiments of the disclosure, the display screen 206 may be realized through several known technologies such as, but are not limited to, at least one of a Liquid Crystal Display (LCD) display, a Light Emitting Diode (LED) display, a plasma display, or an Organic LED (OLED) display technology.

Each of the first set of databases 208 may correspond to an organized collection of data that may be stored and accessed electronically from a computer system (such as the computer system 202). In an embodiment, the first set of databases 208 may store the application 210. Specifically, the first set of databases 208 is configured to store the first source code 216 associated with the application 210. Each database of the first set of databases 208 may be designed to manage, store, retrieve, and update data efficiently. The structure of each database of the first set of databases 208 typically involves tables, records, and fields that may be managed through various database management systems (DBMS). Examples of each database of the first set of databases 208 may include, but are not limited to, a relational database, a Non-Structured Query Language (SQL) database, a hierarchical database, a network database, a transactional database, a data warehouse, and a distributed database.

The application 210 includes a set of instructions, routines, or algorithms that are associated with one or more processes of the application 210. The set of instructions, the routines, or the algorithms may be stored in a computer-readable medium associated with each database of the first set of databases 208. In an embodiment of the disclosure, the computer system 202 is configured to execute the one or more processes of the application 210 within the computational environment 212. The one or more processes include, but are not limited to, data retrieval processes, data validation processes, data storage processes, data rendering processes, and data transmitting processes. Examples of the application 210 include, but are not limited to, web-based applications, mobile applications, cloud-based applications, standalone software programs, and embedded software programs.

The computational environment 212 includes suitable logic, circuitry, and interfaces that are configured to execute one or more instances of the application 210 based on a predefined execution flow associated with the computational environment 212. The one or more instances of the application 210 include programs (such as the first source code 216), classes (such as the set of classes 220), methods, objects, variables, threads, and the like. In an embodiment of the disclosure, the computer system 202 is configured to execute the one or more instances of the application 210 based on the predefined execution flow associated with the computational environment 212. The computational environment 212 is configured to interact with various components of the computer system 202 to execute the application 210. Various components of the computer system 202 include, but are not limited to, a set of hardware (such as the first user device 204) associated with the computer system 202, a set of software (such as the application 210) associated with the computer system 202, a set of networks (such as the WAN 104) associated with the computer system 202, a set of protocols associated with the computer system 202, and a set of interfaces (such as the display screen 206) associated with the computer system 202. Examples of the computational environment 212 include the java environment, the .NET CLR environment, the python interpreter, the Node.js runtime environment, the Go runtime environment, the cloud-based virtual machine, and the like. For brevity, the disclosure hereinafter has been described with respect to the Java environment. However, those skilled in the art would appreciate that the disclosure is applicable on each computational environment.

In an embodiment of the disclosure, the computational environment 212 corresponds to an interpretative computational environment. In the interpretative computational environment, the computer system 202 is configured to generate an intermediate code of high-level instructions associated with the application 210. In an embodiment of the disclosure, the high-level instructions are written in programming languages (such as a Java language, a Python language, a JavaScript language, a Ruby language, and the like). Those having ordinary skills in the art would appreciate that typically a compiler converts the high level instructions into an intermediate code that is further converted to a machine language often referred to as low level language. In an example, an interpreter is configured to convert the intermediate code to the machine code. The intermediate code includes a code structure that is independent of a type of an architecture associated with the computer system 202. In an embodiment of the disclosure, the computer system 202 is configured to execute the machine code in order to execute the application 210. In an example, the application 210.

In an example, the application 210 is a Java application and the first source code 216 is defined as:
System.out.println(“Hello, World!”);

Further, the intermediate code of the first source code 216 corresponds to a set of bytecodes. The set of bytecodes corresponds to a set of instructions that is executable by at least one portion (JVM) of the Java environment. In an example, the JVM is configured to execute the first source code 216 to generate the machine code. The set of bytecodes is defined as:

| | |
|---|---|
| 0: getstaic | #2 |
| 3:Idc | #3 |
| 5: invokevirtual... | #4 |
| 8:return | |

Further, the machine code executable by the computer system 202 is defined as:

B8 00 00 00 00
B9 00 00 00 00
E8 00 00 00 00
C3

In an embodiment of the disclosure, the computational environment 212 corresponds to a compile-based computational environment. In the compile-based computational environment, the computer system 202 is configured to generate a set of low-level instructions based on the high-level instructions. Examples of the low-level instructions include, but are not limited to, a three-address code, a static single assignment, and an assembly language. In an embodiment of the disclosure, the computer system 202 is configured to generate the machine code based on the set of low-level instructions. The computer system 202 is further configured to execute the application 210 based on the machine code. Specifically, in an embodiment of the disclosure, the computer system 202 is configured to execute the machine code in order to execute the application 210. In various embodiments of the disclosure, the computational environment 212 corresponds to a combination of the interpretative environment and the compile-based environment.

The call stack 214 corresponds to memory reserved for the execution of the application 210. In an example, the call stack corresponds to a look-up table that stores a set of call addresses associated with a set of processes in the first source code 216 (corresponding to the application 210), passed parameters (such as the first set of parameters 218, the second set of parameters 226, and the like), local variables of the first source code 216, or a combination thereof. Additionally, the call stack 214 includes call addresses corresponding to the set of classes 220 in the first source code. In an example, the call addresses associated with the set of processes and/or the set of classes 220 correspond to memory addresses of the set of processes and/or the set of classes 220. Examples of call stacks include, but are not limited to, single-threaded call stacks, multi-threaded call stacks, recursive call stacks, parallel computing call stacks, event-driven call stacks, virtual machine call stacks, and kernel call stacks.

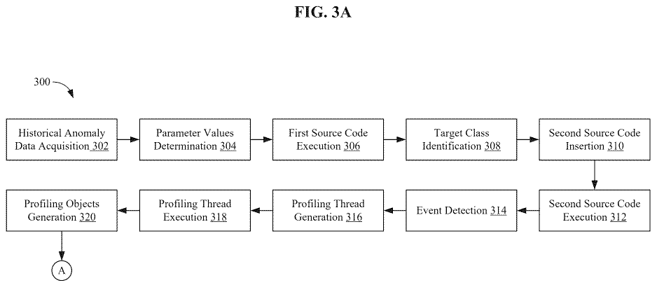

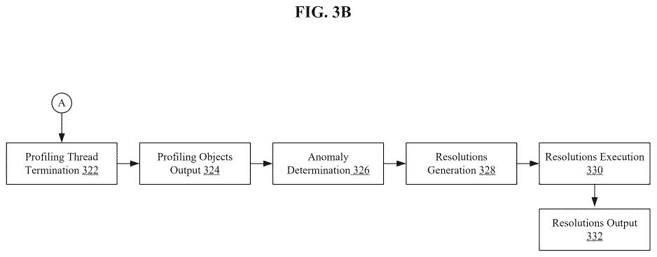

The operation of the computer system 202 is herein further described in conjunction with FIGS. 3A and 3B.

FIG. 3A and FIG. 3B collectively is a diagram that illustrates exemplary operations for generation of profiling objects for profiling process, in accordance with an embodiment of the disclosure. FIG. 3A and FIG. 3B are explained in conjunction with elements from FIG. 1, and FIG. 2. With reference to FIG. 3A and FIG. 3B, there is shown a block diagram 300 that illustrates exemplary operations from 302 to 332, as described herein. The exemplary operations illustrated in the block diagram 300 may start at 302 and may be performed by any computing system, apparatus, or device, such as by the computer 102 of FIG. 1 or the computer system 202 of FIG. 2. Although illustrated with discrete blocks, the exemplary operations associated with one or more blocks of the block diagram 300 may be divided into additional blocks, combined into fewer blocks, or eliminated, depending on the particular implementation.

At 302, a historical anomaly data acquisition operation may be executed. In the historical anomaly data acquisition operation, the computer system 202 is configured to obtain historical anomaly data indicative of a historical occurrence of a set of anomalies within the computational environment 212. Examples of the set of anomalies include, but are not limited to, a memory anomaly associated with an insufficient storage for allocation in the at least one portion (such as a heap storage) of the computational environment 212, a garbage collection anomaly associated with a collection of garbage data of a size (such as 55 megabytes) greater than a garbage memory threshold (such as 50 megabytes), a thread anomaly associated with an occurrence of deadlocks within the computational environment 212, a processing anomaly associated with a high utilization of the computational resources (such as a storage of the computer system 202) associated with the execution of the application 210.

In an embodiment of the disclosure, the computer system 202 is configured to obtain the historical anomaly data from a set of logs associated with the set of processes corresponding to the execution of the application 210. In an example, the computer system is configured to obtain the set of logs from one or more sources, but are not limited to, the computer system 202, the first user device 204, the first set of databases 208, the computational environment 212, and the WAN 104. Additionally, the computer system 202 is configured to obtain the historical anomaly data from a historical set of profiling objects associated with a historical profiling process executed during a historical execution of the application 210.

In an embodiment of the disclosure, the historical anomaly data includes an identifier of each anomaly of the set of anomalies, an identifier of calls that caused the set of anomalies, a duration associated with the historical occurrence of each anomaly of the set of anomalies, or one or more reasons associated with the historical occurrence of each anomaly of the set of anomalies. An example historical anomaly data is illustrated in a Table 1 below:

TABLE 1
illustrating an example historical anomaly data

| | | | | | | Number of |
|---|---|---|---|---|---|---|
| | | | | | One or | Profiling |
| | | Class | | | More | Objects |
| Anomaly | Identifier | identifier | Duration | | Reasons | Generated |
| First | A | Class 1A | 1 | second | Exception | 8 |
| Anomaly | | | | | Detection | |
| Second | B | Class 3B | 5 | second | Processing | 4 |
| Anomaly | | | | | Speed | |
| | | | | | Decrease | |
| Third | C | Class 4C | 0.5 | second | High | 2 |
| Anomaly | | | | | Memory | |
| | | | | | Usage | |

Referring to Table 1, in an example, the historical anomaly data includes an identifier “A” associated with a first anomaly of the set of anomalies, a class identifier “1A” corresponding to a first class (such as the class 222B) of the set of classes 220 that caused the first anomaly. Further, it can be observed that the first anomaly had a duration of “1 second” and was caused because of an exception detection during the execution of the first source code 216. Additionally, during the first anomaly, eight of profiling objects were generated for the first anomaly. The historical anomaly data further includes an identifier “B” associated with a second anomaly of the set of anomalies, a class identifier “3B” corresponding to a second class (such as the class 222C) that caused the second anomaly. Further, it can be observed that the second anomaly had a duration of “5 seconds” and was caused because of a processing speed decrease during the execution of the first source code 216. Additionally, during the second anomaly, four of profiling objects were generated for the second anomaly. The historical anomaly data further includes an identifier “C” associated with a third anomaly of the set of anomalies, a class identifier “4C” corresponding to a third class (such as the class 222N) that caused the third anomaly. Further, it can be observed that the third anomaly had a duration of “0.5 seconds” and was caused because of a high memory usage during the execution of the first source code 216. Additionally, during the third anomaly, two of profiling objects were generated for the third anomaly.

At 304, a parameter values determination operation may be executed. In the parameter values determination operation, the computer system 202 is configured to determine a first set of parameter values for each parameter of the first set of parameters 218 based on the historical anomaly data. In an embodiment of the disclosure, the first set of parameter values includes a target class identifier associated with the at least one the target class (such as the target class 222A).

In an embodiment of the disclosure, the computer system 202 is configured to identify the at least one target class 222A based on a duration associated with the historical occurrence of each anomaly of the set of anomalies. Specifically, the computer system 202 is configured to compare the duration associated with the historical occurrence of each anomaly of the set of anomalies with a time period threshold. Further, the computer system 202 is configured to identify the at least one target class corresponding to an anomaly in the historical anomaly data based on a determination that the time period of the anomaly is greater than the time period threshold. Similarly, the computer system 202 is configured to identify each target class from the set of classes 220 based on the historical anomaly data. In an example, the time period threshold is 0.6 seconds, the duration of the second anomaly is 5 seconds, the computer system 202 is configured to identify the class with the identifier 3B as a target class based on a determination that the duration (5 seconds) of the second anomaly is greater than the time period threshold (0.6 seconds).

In various embodiments of the disclosure, the computer system 202 is configured to identify the at least one target class 222A based on a count of times that each class of the set of classes in the historical anomaly data has caused the set of anomalies. In an example, the computer system 202 is configured to determine the count of times that the class with identifier “4C” in the example historical anomaly data has caused the set of anomalies. Thereafter, the computer system 202 is configured to compare the count of times (such as 7) that the class with identifier “4C” has caused the set of anomalies with a predetermined count threshold (such as 5). If the count of times (such as 7) that class with identifier “4C” has caused the set of anomalies is greater than the predetermined count threshold (such as 5), the computer system 202 is configured to identify the class with the identifier “4C” as the target class.

In various embodiments of the disclosure, the computer system 202 is configured to identify the at least one target class 222A based on the one or more reasons associated with the historical occurrence of each anomaly of the set of anomalies. Specifically, the computer system 202 is configured to identify the at least one target class 222A based on a comparison of the one or more reasons in the example historical anomaly data with at least one predefined reason associated with the historical occurrence of the set of anomalies. In an example, the at least one predefined reason is the processing speed decrease. Further, the computer system 202 is configured to identify the class with identifier “3B” as the target class based on a determination that the third anomaly was caused because of the processing speed decrease in the class with identifier “3B” during the execution of the first source code 216. In an alternative embodiment of the disclosure, the computer system 202 is configured to obtain a first input indicative of a second set of parameter values for each parameter of the first set of parameters from the user 230 associated with the profiling process. A person having ordinary skills in the art would understand that the scope of the disclosure is not limited to the determination of the first set of parameters 218 as described above.

In various embodiments of the disclosure, the computer system 202 is configured to determine a third set of parameter values for each parameter of the second set of parameters 226 based on the historical anomaly data and the first set of parameters 218. In an embodiment of the disclosure, the third set of parameter values includes a sequence parameter value for a sequence parameter of the second set of parameters 226. The sequence parameter is indicative of a set of identifiers associated with the set of events. In an embodiment of the disclosure, the computer system 202 is configured to determine the sequence parameter value based on the historical anomaly data. Referring to table 1, if the computer system 202 identifies the target class as “class 1A”, the computer system 202 is configured to identify the sequence parameter value as “exception detection”.

In an embodiment of the disclosure, the third set of parameter values includes a count parameter value for a count parameter of the second set of parameters 226. The count parameter is indicative of a count associated with the generation of the set of profiling objects 228. Specifically, the count parameter indicates a number of profiling objects for the profiling process. In an embodiment of the disclosure, the computer system 202 is configured to identify the count parameter value based on the historical anomaly data. Referring to table 1, if the computer system 202 identifies the target class as “class 1A”, the computer system 202 is configured to identify the count parameter value as 8.

In an embodiment of the disclosure, the third set of parameter values includes a time period parameter value for a time period parameter of the second set of parameters 226. The time period parameter is indicative of the set of time periods associated with the generation of the set of profiling objects 228. In various embodiments of the disclosure, the computer system 202 is configured to generate the set of profiling objects 228 associated with the computational environment 212 for the set of time periods. In an embodiment of the disclosure, the computer system 202 is configured to determine the time parameter value based on the historical anomaly data. Referring to table 1, if the computer system 202 identifies the target class as “class 1A”, the computer system 202 is configured to identify the time period parameter value as 1 second.

In various embodiments of the disclosure, the computer system 202 is configured to determine the time period parameter value based on the duration associated with the historical occurrence of each anomaly of the set of anomalies and a delta time. In an example, if the computer system identifies the target class as “class 1A”, the delta time is 2 seconds, the duration of the first anomaly associated with the class 1A is 1 second, the computer system 202 is configured to determine the time period parameter value as 3 seconds based on a sum of the duration (1 second) of the first anomaly associated with class 1A and the delta time (2 seconds). In an additional example, the computer system 202 is configured to identify the time parameter value as 1 second based on a difference between the duration (1 second) associated with the historical occurrence of each anomaly of the set of anomalies and the delta time (2 seconds).

In an embodiment of the disclosure, the third set of parameter values includes a type parameter value. The type parameter being indicative of at least a first type associated with the set of profiling objects 228. In an embodiment of the disclosure, the computer system 202 is configured to determine a state of the computer system 202 based on the first type associated with the set of profiling objects 228. Examples of the state of the computational environment 212 include, but are not limited to, a first waiting state, a first new state, a first running state, and a first terminated state. In an example, the first new state of the computational environment 212 is indicative of a first generated thread with respect to the one or more processes associated with the computational environment 212. Similarly, a first running state of the computational environment 212 is indicative of execution of the first generated thread at a time period. A first waiting state of the computing environment 212 indicates that the first generated thread is waiting for a computational resource (such as a storage location within the computational environment 212). The first terminated state of the computational environment 212 indicates that the first generated thread has either completed execution or has been terminated by the computer system 202.

Additionally, the type parameter is further indicative of a second type associated with the set of profiling objects 228. In an embodiment of the disclosure, the computer system 202 is configured to determine a state of the first user device 204 based on the second type associated with the set of profiling objects 228. Examples of the state of the first user device 204 include, but are not limited to, a second waiting state, a second new state, a second running state, and a second state. In an example, the second new state of the first user device 204 is indicative of a second thread with respect to one or more processes associated with the first user device 204. Similarly, a second running state of the computational environment 212 is indicative of execution of the second thread at the time period. A second waiting state of the first user device 204 indicates that the second thread is waiting for the computational resource (such as a storage location within the first user device 204). The second terminated state of the first user device 204 indicates that the second thread has either completed execution or has been terminated by the computer system 202. In various embodiments of the disclosure, the computer system 202 is configured to determine the type parameter value based on the historical anomaly data. In an example, if the computer system identifies the target class as “class 1A”, the computer system 202 is configured to determine the type parameter value as second type. In an additional example, if the computer system 202 identifies the target class as “class 3B”, the computer system 202 is configured to identify the type parameter value as first type. In an alternate embodiment of the disclosure, the computer system 202 is configured to obtain a second input indicative of a fourth set of parameter values for each parameter of the second set of parameters 226 from the user 230 associated with the profiling process. A person having ordinary skills in the art would understand that the scope of the disclosure is not limited to the determination of the second set of parameters 226 as is described above.

At 306, a first source code execution operation may be executed. In the first source code execution operation, the computer system 202 is configured to execute the first source code 216 associated with the application 210 in the computational environment 212. In an embodiment of the disclosure, the computer system 202 is configured to load the set of classes 220 associated with the first source code 216 to the computational environment 212. The computer system 202 is further configured to execute the first source code 216 based on the loading of the set of classes 220 within the computational environment 212. In an embodiment of the disclosure, the computer system 202 is configured to load the set of classes to the computational environment 212 based on a generation of a set of java objects associated with the application 210. In various embodiments of the disclosure, computer system 202 is configured to load the set of classes 220 based on retrieval of static variables associated with the first source code 216. In various embodiments of the disclosure, the computer system 202 is configured to load the set of classes 220 to the computational environment 212 based on execution of one or more methods associated with the first source code 216. In various embodiments of the disclosure, the computer system 202 is configured to load the set of classes 220 to the computational environment 212 based on a set of class loaders associated with the first source code 216. Examples of the set of class loaders include, but are not limited to, bootstrap class loaders, extension class loaders, and application class loaders.

In an embodiment of the disclosure, the computer system 202 is configured to insert at least the first set of parameters 218 and the second set of parameters 226 within the first source code 216 based on a set of command-line instructions associated with the computational environment 212. In an embodiment of the disclosure, the insertion of the first set of parameters 218 and the second set of parameters 226 is referred to as “parameters passing”. An example set of command line instructions is defined as:
javaagent:xtracex.jar=“[the first set of parameters 218][the second set of parameters 226 . . . ]”

In an embodiment of the disclosure, the computer system 202 is configured to execute the first source code 216 based on the first set of parameter values. As discussed above, the first set of parameters 218 includes a target class identifier indicative of the at least one target class 222A. To this end, the computer system 202 is configured to identify the at least one target class 222A from the set of classes 220 in the first source code 216 based on the execution of the first source code 216. In an example, referring to table 1, if the computer system 202 identifies the target class as “class 1A”, the computer system 202 is configured to identify class 1A in the first source code 216 based on the execution of the first source code 216. The identification of the at least one target class 222A during the execution of the first source code 216 is further described at 308.

At 308, a target class identification operation may be executed. In the target class identification operation, the computer system 202 is configured to identify the at least one target class 222A from the set of classes 220 in the first source code 216 based on the execution of the first source code 216. In an embodiment of the disclosure, the computer system 202 is configured to identify the at least one target class 222A from the set of classes 220 based on an occurrence of the set of classes 220 in the call stack 214 associated with the computational environment 212. In an example, the call stack 214 includes the at least memory addresses of the set of classes 220 associated with the first source code 216. The computer system 202 is configured to identify the target class from the call stack 214 during the execution of the first source code 216. The computer system 202 is configured to compare the target class identifier with each identifier of a set of candidate identifiers associated with the occurrence of each class of the set of classes 220 in the call stack 214 associated with the computational environment 212. The computer system 202 is configured to determine a candidate identifier of the set of candidate identifiers corresponds to the target class identifier associated with the at least one target class 222A. The candidate identifier is associated with the occurrence of a candidate class of the set of classes 220. The computer system 202 is configured to identify the at least one target class 222A from the set of classes 220 based on the determination that the candidate identifier of the set of candidate identifiers corresponds to the target class identifier associated with the at least one target class 222A.

In an example, the target class identifier is 0001, a class identifier associated with the at least one target class 222A is 0001, a class identifier associated with the class 222B is 0002, and a class identifier associated with the class 222C is 0003. Specifically, the target class identifier associated with the at least one target class 222A, the class identifier associated with the class 222B, the class identifier associated with the class 222C corresponds to a call address of the at least one target class 222A, a call address of the class 222B, a call address of the class 222C with the call stack 214, respectively. Further, the computer system 202 is configured to determine an occurrence of each class identifier within the call stack 214. In an example, in a first iteration, the computer system 202 is configured to determine that the class identifier (0003) associated with the class 222C is different from the target class identifier (0001) based on the execution of the class 222C. In a second iteration, the computer system 202 is configured to determine the class identifier (0002) associated with the class 222B is different from the target class identifier (0002) based on the execution of the class 222B. In a third iteration, the computer system 202 is configured to determine the class identifier (0001) associated with the at least one target class 222A corresponds to the target class identifier based on the execution of the at least one target class 222A.

At 310, a second source code insertion operation may be executed. In the second source code insertion operation, the computer system 202 is configured to insert the second source code 224 associated with the profiling process within the at least one target class 222A based on the identification of the at least one target class 222A. The second source code 224 includes the second set of parameters 226 associated with the profiling process. In an embodiment of the disclosure, the computer system 202 is configured to update an intermediate form of the at least one target class 222A based on the second source code 224 and the second set of parameters 226. Those having ordinary skills in the art would appreciate that typically the compiler converts the high level language (such as Java) into the intermediate code that is further converted to the machine language often referred to as low level language. The updating of the intermediate form of the at least one target class 222A corresponds to the insertion of the second source code 224 and the second set of parameters 226 within the at least one target class 222A.

In various embodiments of the disclosure, the computer system 202 is configured to determine a result associated with the execution of the java interface. In an embodiment of the disclosure, the result is indicative of the identification of the at least one target class 222A from the set of classes 220. In various embodiments of the disclosure, the result is indicative of an absence of the occurrence of the at least one target class 222A within the call stack 214. The computer system 202 is configured to execute a transform method associated with the Java based on the result. The computer system 202 is configured to update the intermediate form of the at least one target class 222A from the set of classes 220 based on the execution of the transform method.

In an example, the target class identifier for the at least one target class 222A is apache/xerces/impl/XMLDocumentFragmentScannerImpl and a code associated with the execution of the java interface is defined as:

```
Public byte[ ] transform (ClassLoader loader, String
className, Class classBeingRedefined,
ProtectionDomain protectionDomain, byte[ ] classfileBuffer){
  if(className.equals(“class parameter”)) {
    Exception callstack = new Exception( );
    StackTraceElement[ ] stackTrace = callstack.getStackTrace( );
    }
  Return classfileBuffer;
}
```

where, loader—the loader of the class
className—the name of the class with packages separated with “/”
classBeingRedefined—the class being redefined if it's the case, null otherwise
protectionDomain—the protection domain of the class being defined or redefined.

At 312, a second source code execution operation may be executed. In the second source code execution operation, the computer system 202 is configured to execute the second source code 224 associated with the profiling process. In various embodiments of the disclosure, the computer system 202 is configured to execute the second source code 224 based on the insertion of the second source code 224 associated with the profiling process within the at least one target class 222A. Additionally, the computer system 202 is configured to execute the second source code 224 based on the third set of parameter values (such as the sequence parameter value for the sequence parameter, the type parameter value for the type parameter, the count parameter value for the count parameter, the time period parameter value for the time period parameter). By way of example, and not by limitation, the type parameter value for the type parameter (denoted by profilemethod) is java, the count parameter value of the count parameter (denoted by maxdump) is 10, the time period parameter value for the time period parameter (denoted by interval) is 500 millisecond (ms), the second source code 224 associated with the profiling process is defined as:

```
Public void run( ){
String profilemethod=java
Int maxdump=10
Int dumpInterval=500ms
  for (int i =0; I < maxDumps; i++) {
    generateDump( );
    Thread.sleep(interval);
      }
}
```

At 314, an event detection operation may be executed. In an embodiment of the disclosure, the computer system 202 is configured to detect the occurrence of the set of events associated with the at least one target class 222A based on the execution of the second source code 224 including the second set of parameters 226. Specifically, the computer system 202 is configured to execute the second source code 224 based on the sequence parameter of the second set of parameters 226. The sequence parameter is indicative of a set of event identifiers associated with the set of events associated with the at least one target class 222A within the call stack 214. The computer system 202 is configured to determine a set of candidate event identifiers associated with an occurrence of a candidate set of events associated with the at least one target class 222A within the call stack 214 based on the execution of the second source code 224. The computer system 202 is configured to compare a sequence of the set of event identifiers with a sequence of the set of candidate event identifiers. The computer system 202 is configured to determine the sequence of the set of event identifiers corresponds to the sequence of the set of candidate event identifiers. The computer system 202 is configured to detect the occurrence of the set of events associated with the at least one target class 222A within the call stack 214 based on the determination that the sequence of the set of event identifiers corresponds to the sequence of the set of candidate event identifiers.

In an example, the set of event identifiers includes a first identifier (such as 0001) and a second identifier (such as 0002). The set of candidate events associated with the at least one target class 222A includes a slow processing speed event associated with a decrease in a processing speed of the computer system 202 and an input event associated with a reception of an anomaly input from the user 230. The anomaly input is indicative of an occurrence of the decrease in the processing speed. Further, the computer system 202 is configured to determine that a third identifier associated with the slow processing event is 0001 and a fourth identifier associated with the input event is 0002. Further, the computer system 202 is configured to compare a sequence of the first identifier and the second identifier with a sequence of the third identifier and the fourth identifier. Thereafter, the computer system 202 is configured to detect the occurrence of the set of events associated with the at least one target class 222A based on a determination that the sequence (such as 0001 0002) of the first identifier and the second identifier corresponds to the sequence (0001 0002) of the third identifier and the fourth identifier.

At 316, a profiling thread generation operation may be executed. In the profiling thread generation operation, the computer system 202 is configured to generate a profiling thread based on the detection of the occurrence of the set of events associated with the at least one target class 222A within the call stack 214 and the second set of parameters 226. The second set of parameters 226 includes the type parameter indicative of the type associated with the set of profiling objects 228, the count parameter indicative of the count associated with the generation of the set of profiling objects 228, or the time period parameter indicative of the set of time periods associated with the generation of the set of profiling objects 228. The profiling thread corresponds to at least one portion of the second source code 224 that is configured to generate the set of profiling objects 228. In an example, the profiling thread is defined as:

{
Throwable callstack
The transform method is configured to modify getID method
by adding the following logic.
Callstack = new Exception( );
callstack.getStackTrace( ) is used to determine if the run time
current call stack matches the run
option as defined in the following :
com/ibm/cognos/javadumpagent/MyClass.getID
com/ibm/cognos/javadumpagent/Tester.main.
If matches, instantiate JavaProfiler class -that is a new class.
The JavaProfiler class corresponds
to a runnable method that is executed based on JVM commands
to generate the java data dumps,
system data dumps, and the like. }

At 318, a profiling thread execution operation may be executed. In the profiling thread execution operation, the computer system 202 is configured to execute the profiling thread based on the type parameter, the count parameter, the time period parameter, or any combination thereof. Specifically, the computer system 202 is configured to iteratively execute the profiling thread for the set of time periods for the generation of the set of profiling objects 228. In an example, the type parameter value for the type parameter (denoted by profilemethod) is java, the count parameter value of the count parameter (denoted by maxdump) is 10, the time period parameter value for the time period parameter (denoted by interval) is 500 millisecond (ms), the computer system 202 is configured to generate 10 javacores based on an interval of 500 ms.

At 320, a profiling objects generation operation may be executed. In the profiling objects generation operation, the computer system 202 is configured to generate the set of profiling objects 228 associated with the computational environment 212 for the set of time periods based on the detection of the occurrence of the set of events.

In an embodiment of the disclosure, the second source code 224 includes a set of dump commands associated with the generation of the set of profiling objects 228. In an embodiment of the disclosure, the set of dump commands is associated with Java. The computer system 202 is configured to execute the set of dump commands based on the second set of parameters 226. In an embodiment of the disclosure, the second source code 224 includes a set of java dump commands associated with the generation of the first set of profiling objects. The computer system 202 is configured to generate the first set of profiling objects based on the execution of the set of java dump commands. The set of java dump commands are defined as:
com.ibm.jvm.Dump.JavaDump( );

In various embodiments of the disclosure, the computer system 202 is configured to generate a first set of profiling objects of the first type. As discussed, the first type of profiling objects is associated with the computational environment 212. In an example, the first set of profiling objects may be referred to as “a set of java core dumps”. Further, each profiling object of the first set of profiling objects is indicative of a state of the computational environment 212 for the set of time periods. The first state data includes an identifier associated with the computational environment 212, an identifier associated with each thread of a set of threads associated with the application 210, an amount of memory utilized by each thread of the set of threads associated with the application 210, an identifier associated with a class loader of the at least one target class 222A, and the like. In an embodiment of the disclosure, the second source code 224 includes a set of system dump commands associated with the generation of the second set of profiling objects. The computer system 202 is configured to generate the second set of profiling objects based on the execution of the set of javadump commands. The set of javadumps commands is defined as:
com.ibm.jvm.Dump.SystemDump( );

In various embodiments of the disclosure, the computer system 202 is configured to generate a second set of profiling objects of the second type. As described above, the second set of profiling objects is associated with the first user device 204, and the like). In an embodiment of the disclosure, the second set of profiling objects may be referred to as “set of system dumps”. Further, each profiling object of the second set of profiling objects is indicative of a state of the first user device 204 for the set of time periods. The second state data includes an identifier associated with the computational environment 212, an identifier associated with each thread of a set of threads associated with the application 210, an amount of memory utilized by each thread of the set of threads associated with the application 210, an identifier associated with a class loader of the at least one target class 222A, and the like.

At 322, a profiling thread termination operation may be executed. In the profiling objects termination operation, the computer system 202 is configured to execute a thread termination operation for the profiling thread. The thread termination operation includes a deletion of the profiling thread from the computational environment 212. In an embodiment of the disclosure, the computer system 202 is configured to determine a completion of the generation of each profiling object of the set of profiling object 228 based on the execution of the profiling thread. The computer system 202 is configured to execute the thread termination operation for the profiling thread based on the determination of the completion of the generation of each profiling object of the set of profiling objects 228. Specifically, the computer system 202 is configured to deallocate the profiling thread from a memory associated with the computational environment 212 based on the determination of the completion of the generation of each profiling object of the set of profiling objects 228.

At 324, a profiling objects output operation may be executed. In the profiling objects output operation, the computer system 202 is configured to output the set of profiling objects 228. In an embodiment of the disclosure, the computer system 202 is configured to output the set of profiling objects 228 based on the generation of each profiling object of the set of profiling objects 228 at the set of time periods. In an embodiment of the disclosure, the computer system 202 is configured to output the set of profiling objects 228 on a user interface associated with the computer system 202. In various embodiments of the disclosure, the computer system 202 is configured to output the set of profiling objects 228 on the display screen 206 of the first user device 204. In an embodiment of the disclosure, the computer system 202 is configured to store the set of profiling objects 228 within the first set of databases 208. In an embodiment of the disclosure, the computer system 202 is configured to generate an audio alert indicative of the generation of the set of profiling objects 228. In an embodiment of the disclosure, the computer system 202 is configured to generate the audio alert via a set of speakers associated with the computer system 202. In various embodiments of the disclosure, the computer system 202 is configured to generate the audio alert via a set of speakers associated with the computer system 202.

With reference to FIG. 3B, at 326, an anomaly determination operation may be executed. In the anomaly determination operation, the computer system 202 is configured to determine an occurrence of the set of anomalies based on the first set of profiling objects, the second set of profiling objects, or a combination thereof. In an embodiment of the disclosure, the computer system 202 is configured to determine the set of anomalies based on the first state data associated with the first set of profiling objects. The first state data includes an identifier associated with the computational environment 212, an identifier associated with each thread of a set of threads associated with the application 210, an amount of memory utilized by each thread of the set of threads associated with the application 210, an identifier associated with a class loader of the at least one target class 222A, and the like. In an example, the computer system 202 is configured to determine an amount of memory (such as 2 megabytes) utilized by a first set of threads associated with the application 210. Further, the computer system 202 is configured to compare the first amount of memory with a memory threshold (such as 1 megabyte). Further, the computer system 202 is configured to determine an occurrence of the set of anomalies with the computational environment 212 based on a determination that the first amount of memory (such as 2 megabytes) is greater than the memory threshold (such as 1 megabyte). In an additional example, the computer system 202 is configured to determine an occurrence of deadlocks between a first thread and a second thread based on a mapping of an identifier associated with the first thread, an identifier associated with the second thread with an identifier of the computational resource (such as a storage location with the computational environment 212). In an additional example, the computer system 202 is configured to determine a determine an occurrence of the set of anomalies based on a determination that a count (such as 10 megabytes) of the execution of the at least one target class 222A is greater than a predefined execution count threshold (such as 5 megabytes).

At 328, a resolutions generation operation may be executed. In the resolutions generation operation, the computer system 202 is configured to generate a set of resolutions based on the generated set of profiling objects and the determination of the occurrence of the set of anomalies. The set of resolutions is generated to resolve the set of anomalies. In an embodiment of the disclosure, the computer system 202 is configured to obtain a historical set of resolutions associated with the historical anomaly data. In the embodiment of the disclosure, the computer system 202 is configured to generate the set of resolutions based on the historical set of resolutions. In an example, the computer system 202 is configured to determine that the amount of memory (such as 10 megabytes) utilized by the first set of threads is greater than the memory threshold (such as 5 megabytes) based on the set of profiling objects 228. Further, referring back to table 1, the computer system 202 is configured to identify the target class as “class 4C” and determine that the third anomaly had occurred in the class 4C due to the high memory usage. Further, the computer system 202 is configured to generate a set of memory resolutions. The set of memory resolutions is generated based on the high memory usage. The set of memory resolutions include, but are not limited to, a collection of the garbage data associated with the computational environment 212, an increase in a size associated with the heap storage of the computational environment 212, and a deletion of redundant data associated with the computational environment 212. The resolution of the set of anomalies based on the generated set of resolutions allows the computer system 202 to increase a computational speed of the computational environment 212. Additionally, the resolution of the set of anomalies based on the generated set of resolutions allows the computer system 202 to decrease a probability of downtime of the computational environment 212 due to the occurrence of the set of anomalies. Moreover, the resolution of the set of anomalies allows the computer system 202 to increase a user experience of a user of the computational environment 212.

At 330, a resolutions execution operation may be executed. In the resolutions execution operation, the computer system 202 is configured to execute the generated set of resolutions. In various embodiments of the disclosure, the computer system 202 is configured to execute the generated set of resolutions based on the generation of the set of resolutions. In an embodiment of the disclosure, the computer system 202 is configured to control at least one database of the first set of databases 208 to execute the generated set of resolutions.

At 332, a resolutions output operation may be executed. In the resolutions output operation, the computer system 202 is configured to output the set of resolutions. In an embodiment of the disclosure, the computer system 202 is configured to output the set of resolutions based on the determination of the occurrence of the set of anomalies. In an embodiment of the disclosure, the computer system 202 is configured to output the set of resolutions on the user interface associated with the computer system 202. In various embodiments of the disclosure, the computer system 202 is configured to output the set of resolutions on the display screen 206 of the first user device 204. In an embodiment of the disclosure, the computer system 202 is configured to store the set of resolutions within the first set of databases 208. In an embodiment of the disclosure, the computer system 202 is configured to generate an audio alert indicative of the generation of the set of resolutions. In an embodiment of the disclosure, the computer system 202 is configured to generate the audio alert via the set of speakers associated with the computer system 202. In various embodiments of the disclosure, the computer system 202 is configured to generate the audio alert via the set of speakers associated with the computer system 202.

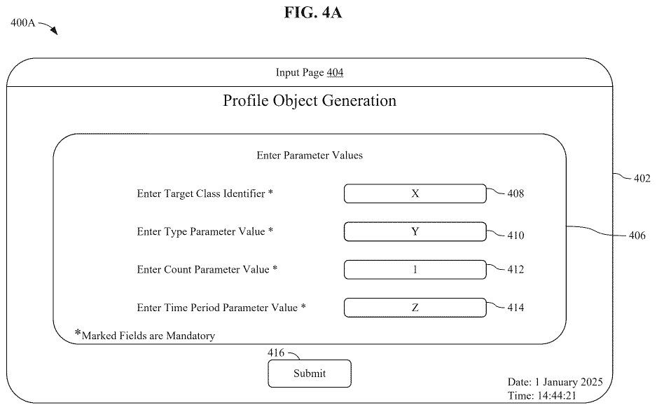

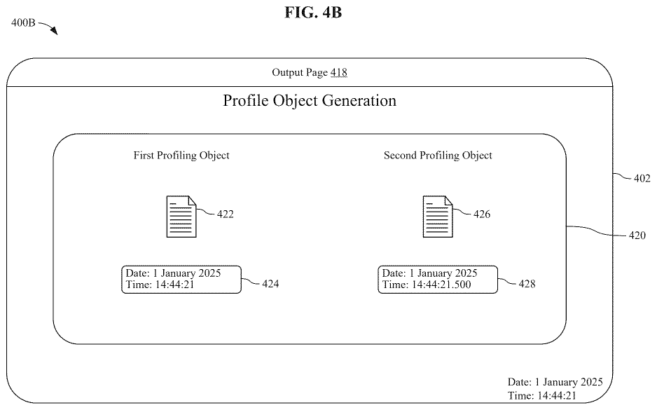

FIG. 4A is a diagram that illustrates an exemplary first user interface for generation of profiling objects for profiling objects, in accordance with an embodiment of the disclosure. FIG. 4A is explained in conjunction with elements from FIG. 1, FIG. 2, FIG. 3A, and FIG. 3B. With reference to FIG. 4A, there is shown an exemplary diagram 400A that includes a user device 402 and an exemplary input page 404. The exemplary input page 404 includes a first user interface (UI) element 406, a second UI element 408, a third UI element 410, a fourth UI element 412, a fifth UI element 414, and a sixth UI element 416. The user device 402 is an example embodiment of the first user device 204 of FIG. 2.

With reference to FIG. 4A, the computer system 202 is configured to receive one or more inputs from the user device 402. The user device 402 includes a display unit that renders the exemplary input page 404 on the user device 402 to be seen by the user 230. In an embodiment, the exemplary input page 404 corresponds to a web page or an online form that is designed to collect information from the user 230 who wishes to generate the set of profiling objects 228. In an embodiment of the disclosure, the exemplary input page 404 is used to gather relevant data from the user 230 to generate the set of profiling objects 228.

The first UI element 406 corresponds to a textbox that includes a message for the user 230, for example, “Enter Parameter Values”. The first UI element 406 further includes the second UI element 408, the third UI element 410, the fourth UI element 412, and the fifth UI element 414. The second UI element 408 corresponds to a textbox labeled “Enter Target Class Identifier”. The second UI element 408 is configured to receive the target class identifier of the first set of parameters 218. In an embodiment of the disclosure, the second UI element 408 is a mandatory input parameter that needs to be provided for the generation of the set of profiling objects 228.

The third UI element 410 corresponds to a textbox labeled “Enter Type Parameter Value”. The third UI element 410 is configured to receive the type parameter value for the type parameter value of the second set of parameters 226. In an embodiment of the disclosure, the third UI element 410 is a mandatory input parameter that needs to be provided for the generation of the set of profiling objects 228. The fourth UI element 412 corresponds to a textbox labeled “Enter Count Parameter Value”. The fourth UI element 412 is configured to receive the count parameter value for the generation of the set of profiling objects 228. In an embodiment of the disclosure, the fourth UI element 412 is a mandatory input parameter that needs to be provided for the generation of the set of profiling objects 228.

The fifth UI element 414 corresponds to a textbox labeled “Enter Time Period Parameter Value”. The fifth UI element 414 is configured to receive the time period parameter value for the generation of the set of profiling objects 228. In an embodiment of the disclosure, the fifth UI element 414 is a mandatory input parameter that needs to be provided for the generation of the set of profiling objects 228.

The sixth UI element 416 corresponds to a button and is labeled as “Submit”. Upon selecting the sixth UI element 416, the computer system 202 is configured to generate the set of profiling object 228.

FIG. 4B is a diagram that illustrates an exemplary second user interface for generation of the profiling objects for profiling process, in accordance with an embodiment of the disclosure. FIG. 4B is explained in conjunction with elements from FIG. 1, FIG. 2, FIG. 3A, FIG. 3B, and FIG. 4A. With reference to FIG. 4B, there is shown an exemplary diagram 400B that includes the user device 402 and an exemplary output page 418. The exemplary output page 418 includes a seventh UI element 420 that includes an eighth UI element 422, a ninth UI element 424, a tenth UI element 426, and an eleventh UI element 428. The user device 402 is an example embodiment of the first user device 204 of FIG. 2.

With reference to FIG. 4B, the computer system 202 is configured to output a first profiling object and a second profiling object on the exemplary second user interface. The user device 402 includes the display unit (a user interface) that renders the exemplary output page 418 to the user 230. The computer system 202 is configured to render the exemplary output page 418 on the user interface (UI) of the user device 402. The exemplary output page 418 corresponds to a web page or online form that is designed to display the first profiling object and the second profiling object.

The seventh UI element 420 corresponds to a set of textboxes labeled as “First Profiling Object” at the left portion of the seventh UI element 420 and “Second Profiling Object” at the right portion of the seventh UI element 420.

The eighth UI element 422 corresponds to a digital representation of the first profiling object. The ninth UI element 424 is configured to render a first time period value for the first profiling object. The tenth UI element 426 corresponds to a digital representation of the first second object. The eleventh UI element 428 is configured to render a second time period value for the second profiling object.

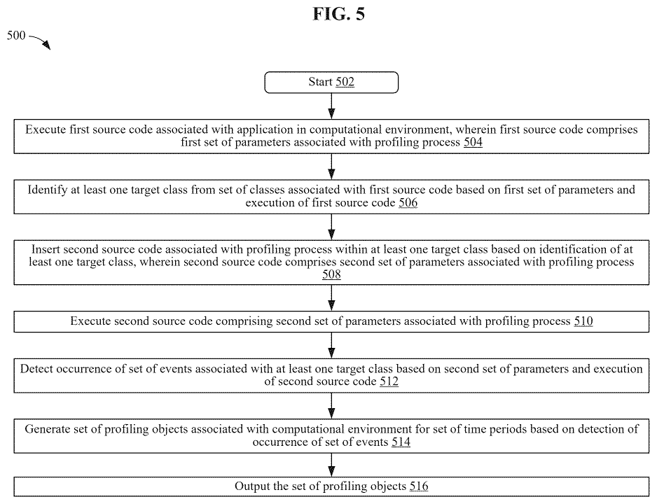

FIG. 5 is a diagram that illustrates flowchart 500 of a method for generation of profiling objects for profiling process, in accordance with an embodiment of the disclosure. FIG. 5 is explained in conjunction with elements from FIG. 1, FIG. 2, FIG. 3A, FIG. 3B, FIG. 4A and FIG. 4B. The operations of the method depicted by the flowchart 500 may be executed by any computing system, for example, by the computer 102 of FIG. 1 or the computer system 202 of FIG. 2. The operations of flowchart 500 may start at 502.

At 504, the first source code 216 associated with the application 210 is executed in the computational environment 212. The first source code 216 includes the first set of parameters 218 associated with the profiling process. In an embodiment of the disclosure, the computer system 202 is configured to execute the first source code 216 associated with the application 210 in the computational environment 212. Details about the execution of the first source code 216 are provided, for example, in FIG. 3A and FIG. 3B.

At 506, the at least one target class 222A from the set of classes 220 associated with the first source code 216 is identified based on the first set of parameters 218 and the execution of the first source code 216. In an embodiment of the disclosure, the computer system 202 is configured to identify the at least one target class 222A from the set of classes 220 associated with the first source code 216 based on the first set of parameters 218 and the execution of the first source code 216. Details about the identification of the at least one target class 222A from the set of classes 220 are provided, for example, in FIG. 3A and FIG. 3B.

At 508, the second source code 224 associated with the profiling process is inserted within the target class 222A based on the identification of the at least one target class 222A. The second source code 224 includes the second set of parameters 226 associated with the profiling process. In an embodiment of the disclosure, the computer system 202 is configured to insert the second source code 224 associated with the profiling process within the at least one target class 222A based on the identification of the at least one target class 222A. Details about the insertion of the second source code 224 within the at least one target class 222A are provided, for example, in FIG. 3A and FIG. 3B.

At 510, the second source code 224 is executed. The second source code 224 includes the second set of parameters 226 associated with the profiling process. In an embodiment of the disclosure, the computer system 202 is configured to execute the second source code 224 including the second set of parameters 226 associated with the profiling process. Details about the execution of the second source code 224 are provided, for example, in FIG. 3A and FIG. 3B.

At 512, the occurrence of the set of events associated with the at least one target class 222A is detected based on the second set of parameters 226 and the execution of the second source code 224. In an embodiment of the disclosure, the computer system 202 is configured to detect the occurrence of the set of events associated with the at least one target class 222A based on the second set of parameters 226 and the execution of the second source code 224. Details about the detection of the occurrence of the set of events associated with the at least one target class 222A are provided, for example, in FIG. 3A and FIG. 3B.

At 514, the set of profiling objects 228 associated with the computational environment 212 are generated for the set of time periods based on the detection of the occurrence of the set of events. In an embodiment of the disclosure, the computer system 202 is configured to generate the set of profiling objects 228 associated with the computational environment 212 for the set of time periods based on the detection of the occurrence of the set of events. Details about the generation of the set of profiling objects 228 are provided, for example, in FIG. 3A and FIG. 3B.

At 516, the set of profiling objects 228 is output. In an embodiment of the disclosure, the computer system 202 is configured to output the set of profiling objects 228. Details about the output of the set of profiling objects 228 are provided, for example, in FIG. 3A and FIG. 3B.

While the above operations shown in FIG. 5 are described in a particular sequence, the operations may occur in variations to the sequence in accordance with various embodiments of the present disclosure. Further, details related to various operations of FIG. 5 which are already covered in the description related to FIG. 1, FIG. 2, FIG. 3A, FIG. 3B, FIG. 4A, and FIG. 4B are not discussed again in detail here for the sake of brevity.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
executing, by a computer, a first source code associated with an application in a computational environment, wherein the first source code comprises a first set of parameters associated with a profiling process;
identifying, by the computer, at least one target class from a set of classes associated with the first source code based on the first set of parameters and the execution of the first source code;
inserting, by the computer, a second source code associated with the profiling process within the at least one target class based on the identification of the at least one target class, wherein the second source code comprises a second set of parameters associated with the profiling process;
executing, by the computer, the second source code comprising the second set of parameters associated with the profiling process;
detecting, by the computer, an occurrence of a set of events associated with the at least one target class based on the second set of parameters and the execution of the second source code;
generating, by the computer, a set of profiling objects associated with the computational environment for a set of time periods based on the detection of the occurrence of the set of events; and
outputting, by the computer, the set of profiling objects.

2. The computer-implemented method of claim 1, further comprising:
determining, by the computer, an occurrence of a set of anomalies within the computational environment, wherein the occurrence of the set of anomalies is determined based on the generated set of profiling objects;
generating, by the computer, a set of resolutions based on the generated set of profiling objects and the determination of the occurrence of the set of anomalies, wherein the set of resolutions is generated to resolve the set of anomalies; and
outputting, by the computer, the set of resolutions.

3. The computer-implemented method of claim 2, further comprising:
obtaining, by the computer, historical anomaly data indicative of a historical occurrence of the set of anomalies within the computational environment;
determining, by the computer, a set of parameter values for each parameter of the first set of parameters based on the historical anomaly data; and
executing, by the computer, the first source code based on the set of parameter values.

4. The computer-implemented method of claim 2, further comprising:
obtaining, by the computer, historical anomaly data indicative of a historical occurrence of the set of anomalies within the computational environment;
determining, by the computer, a set of parameter values for each parameter of the second set of parameters based on the historical anomaly data and the first set of parameters; and
executing, by the computer, the second source code based on the set of parameter values.

5. The computer-implemented method of claim 4, wherein the historical anomaly data comprises at least one of an identifier associated with each anomaly of the set of anomalies, a duration associated with the historical occurrence of each anomaly of the set of anomalies, or one or more reasons associated with the historical occurrence of each anomaly of the set of anomalies.

6. The computer-implemented method of claim 1, further comprising:
identifying, by the computer, the at least one target class from the set of classes based on an occurrence of each class of the set of classes in a call stack associated with the computational environment, wherein the call stack comprises at least memory addresses of the set of classes associated with the first source code.

7. The computer-implemented method of claim 6, further comprising:
executing, by the computer, the first source code based on a target class identifier associated with the at least one target class;
comparing, by the computer, the target class identifier with each identifier of a set of candidate identifiers based on the target class identifier and the execution of the first source code, wherein the set of candidate identifiers is associated with the occurrence of each class of the set of classes in the call stack associated with the computational environment;
determining, by the computer, that a candidate identifier of the set of candidate identifiers corresponds to the target class identifier based on the comparison of the target class identifier with each identifier of the set of candidate identifiers, wherein the candidate identifier is associated with the occurrence of a candidate class of the set of classes; and
identifying, by the computer, the at least one target class from the set of classes based on the determination that the candidate identifier corresponds to the target class identifier.

8. The computer-implemented method of claim 7, further comprising:
executing, by the computer, the second source code based on a sequence parameter of the second set of parameters, wherein the sequence parameter is indicative of a set of event identifiers associated with the set of events associated with the at least one target class within the call stack;
determining, by the computer, a set of candidate event identifiers associated with an occurrence of a candidate set of events associated with the at least one target class within the call stack, wherein the set of candidate event identifiers is determined based on the sequence parameter and the execution of the second source code;
comparing, by the computer, a sequence of the set of event identifiers with a sequence of the set of candidate event identifiers;
determining, by the computer, that the sequence of the set of event identifiers corresponds to the sequence of the set of candidate event identifiers, based on the comparison of the sequence of the set of event identifiers with the sequence of the set of candidate event identifiers; and
detecting, by the computer, the occurrence of the set of events associated with the at least one target class within the call stack based on the determination that the sequence of the set of event identifiers corresponds to the sequence of the set of candidate event identifiers.

9. The computer-implemented method of claim 8, further comprising:
generating, by the computer, a profiling thread based on the detection of the occurrence of the set of events associated with the at least one target class within the call stack and the second set of parameters, wherein the second set of parameters comprises at least one of a type parameter indicative of a type associated with the set of profiling objects, a count parameter indicative of a count associated with the generation of the set of profiling objects, or a time period parameter indicative of the set of time periods associated with the generation of the set of profiling objects.

10. The computer-implemented method of claim 9, further comprising:
executing, by the computer, the profiling thread based on the at least one of the type parameter, the count parameter, or the time period parameter; and
generating, by the computer, the set of profiling objects associated with the computational environment at the set of time periods based on the execution of the profiling thread.

11. The computer-implemented method of claim 10, further comprising:
determining, by the computer, a completion of the generation of each profiling object of the set of profiling objects based on the execution of the profiling thread; and
executing, by the computer, a thread termination operation for the profiling thread based on the determination of the completion of the generation of each profiling object of the set of profiling objects.

12. The computer-implemented method of claim 10, further comprising:
executing, by the computer, the profiling thread based on at least the count parameter, the time period parameter, and the type parameter being indicative of at least a first type associated with the set of profiling objects; and
generating, by the computer, the set of profiling objects comprising a first set of profiling objects associated with the computational environment based on the first type associated with the set of profiling objects and the execution of the profiling thread, wherein each profiling object of the first set of profiling objects is indicative of at least first state data associated with a state of the computational environment at the set of time periods, and wherein the first set of profiling objects is generated at the set of time periods.

13. The computer-implemented method of claim 12, further comprising:
executing, by the computer, the profiling thread based on at least the count parameter, the time period parameter, and the type parameter further indicative of a second type associated with the set of profiling objects; and
generating, by the computer, the set of profiling objects comprising a second set of profiling objects associated with a computer system based on the second type associated with the set of profiling threads and the execution of the profiling thread, wherein each profiling object of the second set of profiling objects is indicative of at least second state data associated with a state of the computer system at the set of time periods, and wherein the second set of profiling objects is generated at the set of time periods.

14. The computer-implemented method of claim 1, further comprising:
obtaining, by the computer, a first input indicative of a set of parameter values for each parameter of the first set of parameters from a user associated with the profiling process; and
executing, by the computer, the first source code based on the set of parameter values.

15. The computer-implemented method of claim 1, further comprising:
obtaining, by the computer, a second input indicative of a set of parameter values for each parameter of the second set of parameters from a user associated with the profiling process; and
executing, by the computer, the second source code based on the set of parameter values.

16. A computer system, comprising:
a processor set;
one or more computer-readable storage media; and
program instructions stored on the one or more computer-readable storage media, the program instructions executable by the processor set to cause the processor set to:
execute a first source code associated with an application in a computational environment, wherein the first source code comprises a first set of parameters associated with a profiling process;
identify at least one target class from a set of classes associated with the first source code based on the first set of parameters and the execution of the first source code;
insert a second source code associated with the profiling process within the at least one target class based on the identification of the at least one target class, wherein the second source code comprises a second set of parameters associated with the profiling process;
execute the second source code and the second set of parameters associated with the profiling process;
detect an occurrence of a set of events associated with the at least one target class based on the second set of parameters and the execution of the second source code;
generate a set of profiling objects associated with the computational environment at a set of time periods based on the detection of the occurrence of the set of events; and
output the set of profiling objects.

17. The computer system of claim 16, wherein the program instructions further cause the processor set to:
determine an occurrence of a set of anomalies within the computational environment, wherein the occurrence of the set of anomalies is determined based on the generated set of profiling objects;
generate a set of resolutions based on the generated set of profiling objects and the determination of the occurrence of the set of anomalies, wherein the set of resolutions is generated to resolve the set of anomalies; and
output the set of resolutions.

18. The computer system of claim 17, wherein the program instructions further cause the processor set to:
obtain historical anomaly data indicative of a historical occurrence of the set of anomalies within the computational environment;
determine a set of parameter values for each parameter of the first set of parameters based on the historical anomaly data; and
execute the first source code based on the set of parameter values.

19. The computer system of claim 17, wherein the program instructions further cause the processor set to:
obtain historical anomaly data indicative of a historical occurrence of the set of anomalies within the computational environment;
determine a set of parameter values for each parameter of the second set of parameters based on the historical anomaly data and the first set of parameters; and
execute the second source code based on the set of parameter values.

20. A computer program product for generation of profiling objects for detection of an anomaly, the computer program product comprising:
one or more computer-readable storage media; and
program instructions stored on the one or more computer-readable storage media to perform operations comprising:
executing a first source code associated with an application in a computational environment, wherein the first source code comprises a first set of parameters associated with a profiling process;
identifying at least one target class from a set of classes associated with the first source code based on the first set of parameters and the execution of the first source code and the first set of parameters;
inserting a second source code associated with the profiling process within the target class based on the identification of the at least one target class, wherein the second source code, and a second set of parameters associated with the profiling process;
executing the second source code and the second set of parameters associated with the profiling process;
detecting an occurrence of a set of events associated with the at least one target class based on the second set of parameters and the execution of the second source code;
generating a set of profiling objects associated with the computational environment at a set of time periods based on the detection of the occurrence of the set of events; and
outputting the set of profiling objects.
